(19) United States
(12) Patent Application Publication
(10) Pub. No.: US 2010/0225547 A1
(43) Pub. Date: Sep. 9, 2010

(54) Vehicle concealed antenna

(76) Inventors: Kang Lan, Aurora (CA); Harry Guo, North York (CA); Jan Koivunen, Thornhill (CA); Rudolf F. Riemann, Scarborough (CA)

Correspondence Address: DOWELL & DOWELL P.C., 103 Oronoco St., Suite 220, Alexandria, VA, 22314, US

(21) Appl. No.: 12/382,005

(22) Filed: Mar. 5, 2009

(51) Int. Cl. H01Q 1/50; H01Q 1/32

(52) U.S. Cl. 343/713; 343/861; 29/428

(57) ABSTRACT

An antenna assembly for use in a vehicle is provided, whereby the assembly is preferably concealed within a vehicle bumper or non-conductive fender. The assembly includes a flexible antenna radiator directly connected with an output of a tunable matching circuit contained within a housing, whereby the housing further provides a connection means between the input of the matching circuit and a radio system in the vehicle. The matching circuit is tunable by control means provided externally on the housing, enabling the antenna assembly to be easily tuned prior to or during installation. The inventive antenna assembly advantageously provides a low cost antenna with ease of installation, small size, and direct integration with a tunable matching circuit.

### FIELD OF THE INVENTION

The invention relates to a vehicle antenna for radio frequency signal transmission and reception. More particularly, the invention relates to a compact antenna assembly for concealment within a vehicle bumper.

### BACKGROUND OF THE INVENTION

Concealed antennas are used in vehicles for a number of applications, including the public safety applications such as the disguising of police car antennas and aesthetic applications in the general automotive market. Antennas of this type are generally known as disguised, concealed or hidden antennas.

There are, in general, two main types of concealed antennas. The first type is the covert antenna, which is visible but cannot be distinguished from a regular antenna. An example of a covert antenna is converting the traditional fender mount or roof mount AM/FM radio antennas to VHF or UHF land mobile radio antennas. The second type of a concealed antenna is a hidden antenna, where the antenna is hidden within or under the vehicle body. This kind of antenna typically has specific size requirements, for example, a hidden antenna should be small in size, or may be large in physical size but with slim or flat structures that conform to a portion of the vehicle body.

Several different designs and applications of concealed antenna are known in the prior art. One initial design involved a modified AM/FM broadcast fender mount vehicle antenna, which is known to have very good signal transmission and reception. However, the major disadvantage of this design is that as many modern vehicles no longer use traditional AM/FM antennas, and such a disguise will likely no longer be possible in the near future. Cellular glass mount antennas also have very good signal transmission and reception and are universal for different vehicles. However, this type of antenna is also not commonly used in modern vehicles.

Another example is the cabin mount antenna, where the antenna is installed inside the vehicle cabin, generally above the rear window of a car or side window of a van or SUV. This type of design is modularized and can be installed in a variety of vehicles. However, this antenna has the disadvantage of high RF exposure levels when functioning as a transmitter antenna. Additionally, this type of antenna is not easily concealed.

Nonetheless, visible antennas will still be used for many types of vehicles in the future. However, these antennas are small and low profile antennas and are typically used for GPS and cellular applications. These antennas cannot be converted for lower frequency band applications such as VHF and UHF systems. Also, many types of vehicles are now using AM/FM antennas printed on the window glass. However, such antennas cannot handle sufficiently high power to operate as a transmitter antenna, and also do not comply with many RF safety regulations.

Accordingly, a preferred design for a concealed antenna involves hiding the antenna within the vehicle. The design of hidden antennas presents several design challenges, and one must strive to optimize the following features: antenna efficiency, omni-directivity, low RF exposure, universality, compact antenna size, and material and installation cost. As an example, the transponder antenna for a keyless entry system can be printed on a very small piece of PCB so that it can be easily installed in the dash board, thus meeting the requirements for low cost and low size. However this kind of antenna can only be useful in low power and short range applications, where antenna efficiency and omni-directivity can be compromised.

A better option is to conceal an antenna inside a vehicle bumper or fender, since this design results in lower RF exposure to the passengers. Antennas of this type can be completely disguised and do not involve the use of any existing vehicle antennas. A universal configuration is also possible since many vehicles have similar bumper configurations. Placing the antenna within the fender or bumper has the additional advantage of reducing the chance of damage due to vandalism, car washing and flying debris.

U.S. Pat. No. 6,943,740 discloses a design that uses a license plate as the antenna radiator and a coaxial cable as the feed cable. The connection between the feed cable and the license plate is realized by bolting the cable to the license plate using an electrically insulated or plastic nut. The feed cable and the connection are hidden behind the bumper so the antenna is disguised. Since the license plate is exposed and close to the ground, the reliability and durability are questionable under snow, ice, salt and other extreme weather conditions.

While the aforementioned patent teaches the matching of the antenna by cutting cable stub lengths, it is readily found that this is a very difficult method for tuning the antenna to a desired frequency. Another concern is that it is difficult to balance the feed cable, which can cause unbalanced current flowing on the shield of the coaxial cable. This in turn will reduce the antenna efficiency, increase the antenna noise and make the antenna unstable. Furthermore, when multiple antennas are required for improved omni-directionality and diversity purposes, this type of antenna can be used only for vehicles that have both front and rear license plates and limits the maximum number of antennas to two. For vehicles with only one license plate, other types of antennas have to be integrated with the system.

U.S. Pat. No. 6,870,510 presented a slot type antenna comprising a conductive surface housed in the bumper. The conductive surface forms, on a side facing toward the vehicle body, a slot with respect to the body panel, which may be used for the guiding of radio waves. The conductive surface may extend substantially over the entire width of the bumper so that even low frequencies may still be received effectively. According to the disclosure, this antenna can work with several inputs of the diversity receiver. This invention appears to be restricted in its practical use, as the disclosure teaches the antenna for use in reception only, it is expected that the design would need to be modified for transmission. The major drawback of this antenna is that it is horizontally polarized. In particular, if this type of designs is used in land mobile radio systems, considerable signal drop is expected when the mobile system is communicating with the base station where signals are generally transmitted vertically.

Vehicle bumpers are typically filled with stiff foam material to absorb the energy of a collision. In the aforementioned invention, the integration of the conductive surface requires significant cutting of the foam. Since the conductive surface is comparatively large for many land mobile radio systems, significantly altering the foam may present regulatory and liability concerns. According to the present legislation, a bumper must be able to survive a deformation at low speeds and thereafter resume its initial shape and function. However the conductive surface embedded inside the bumper, and especially the slot formed between the conductive surface and the vehicle body, may be susceptible to distortion easily, which may impair the performance of the antenna.

An elastic antenna element, as disclosed in U.S. Pat. No. 6,433,748, is a better choice to survive in a collision. However, a major concern for this invention is again the antenna polarization. The antenna alignment proposed in the prior art results in poor coverage when single antenna is implemented, as noted in other designs discussed above.

U.S. Pat. No. 5,926,142 discloses a receiving antenna mounted within the fender of a vehicle, while the antenna amplifier is mounted on the opposite of a structure wall. The antenna can be plugged into the amplifier box and a water-tight bushing is used to seal the connection. Vehicle manufacturers can use this design to install AM/FM antennas easily. Unfortunately, this design is only applicable for reception antennas. For antennas to be used for transmission and reception, the impedance between the antenna and the transceiver has to be critically matched and a matching circuit is therefore required. The effect of the vehicle body on the antenna performance is also more sensitive, and thus a fine-tuning mechanism would need to be introduced to optimize the antenna performance.

Accordingly, there is a need for an antenna that can be easily integrated into and hidden within a bumper or fender, supports the transmission and reception of radio signals, provides a means of matching the antenna to achieve optimal performance, and is easily to install in a new or used vehicle.

### SUMMARY OF THE INVENTION

The present invention provides an improved antenna assembly for use in a vehicle in a concealed fashion. Unlike prior art antennas, the present invention provides an antenna assembly that has the advantages of low cost, ease of installation, small size, and direct integration with a tunable matching circuit.

In a preferred embodiment, the present invention provides an antenna assembly adapted for use with a vehicle, comprising an antenna radiator, a matching circuit contained within a housing, and control means for tuning the matching circuit. The housing further includes a first external connection means for directly connecting the output of the matching circuit to the antenna radiator and a second external connection means for connecting the input of the matching circuit to a radio system.

In a preferred embodiment, the antenna radiator is a flexible wire coated with a dielectric, and the wire is connected, with strain relief and weatherproofing, to the center pin of a male coaxial connector. This enables the antenna radiator to be directly interfaced with the first external connection means of the housing, which is preferably a female flange-mounted connector. Additionally, the second external connection of the housing is a flange-mounted connector, and where a coaxial cable is connected between a radio system in a vehicle and the flange-mounted connector.

The flexible antenna assembly is preferably adapted for concealment within a bumper or fender of a vehicle. The antenna radiator can be attached to foam inside a bumper, or supported by form or a non-metallic spacer inside a fender, provided that the bumper or fender cover is made of a non-conductive material.

The housing is preferably a weather-proofed conductive housing which is used to protect the matching and tuning circuit, and also provides grounding to the antenna assembly when connected to a conductive support within the vehicle.

The tunable matching circuit provides a means to optimize the antenna performance, which is especially important for concealed vehicle antennas because differences in bumper or vehicle body geometry and size and also the mounting position of the antenna can have a significant impact on the antenna performance. The matching circuit is preferably a LC circuit, and the tuning means is preferably a tuning screw of a capacitor trimmer. The tuning circuit is preferably contained in the housing in such a way that the capacitors are in shunt and that the capacitor trimmers can be mounted on the antenna base wall, thereby allowing a tuning screw to be accessed from outside of the housing.

In another preferred embodiment, the invention provides an antenna system concealed within a vehicle, comprising one or more antenna assemblies as described above, and wherein said one or more antenna assemblies are connected to a radio transmitter, receiver or transceiver.

In a further embodiment, the antenna system is a diversity system that includes multiple antenna assemblies in order to obtain improved signal quality. In a preferred embodiment, more than one antenna is installed in different corners of front and/or rear bumpers, and a divider circuit is used to combine antenna signals for processing by a transceiver. In another embodiment, multiple antenna assemblies are connected to a switch, where the switch is used to connect the single antenna assembly with optimal signal quality to a transceiver. In yet another preferred embodiment, the multiple antenna assemblies are employed in a multiple-input multiple-output (MIMO) diversity system.

A further understanding of the functional and advantageous aspects of the invention can be realized by reference to the following detailed description and drawings.

### BRIEF DESCRIPTION OF THE DRAWINGS

Preferred embodiments of the invention will now be described, by way of example only, with reference to the drawings, in which:

FIG. 1 shows multiple antennas being combined to improve omni-directional coverage;

FIG. 2 shows the configuration of the transceiver being switched to one of several antennas having the best signal;

FIG. 3 shows the application of multiple antennas for use with a MIMO transceiver;

FIG. 4 shows a perspective view of the invention in a vehicle bumper;

FIG. 5 shows the assembly of the invention when a metal wire is used as the antenna radiator;

FIG. 6 shows the assembly of the invention when a shortened metal wire loaded with coils is used as the antenna radiator;

FIG. 7 shows a detailed view of the antenna radiator assembly using metal wire;

FIG. 8 shows a detailed view of the antenna radiator assembly using shortened metal wire loaded coils;

FIG. 9 shows the antenna feed cable assembly; and

FIG. 10 shows four (4) detailed views of the antenna housing and the matching and tuning circuit.

### DETAILED DESCRIPTION OF THE INVENTION

The embodiments described herein are directed to an antenna assembly for use in a vehicle in a concealed fashion, an antenna system concealed within a vehicle, and a method of installation of a concealed antenna assembly in a vehicle. As required, embodiments of the present invention are disclosed herein. However, the disclosed embodiments are merely exemplary, and it should be understood that the invention may be embodied in many various and alternative forms.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, a concealed modular antenna is disclosed herein.

As used herein, the terms “about”, and “approximately” when used in conjunction with ranges of dimensions, sizes or other physical or chemical properties or characteristics is meant to cover slight variations that may exist in the upper and lower limits of the ranges of properties/characteristics.

The present invention provides an antenna assembly that can be easily installed into used vehicles as an aftermarket assembly, or can be integrated into a new vehicle during assembly of the new vehicle. The antenna assembly includes an antenna radiator that is directly connected to a housing containing a matching circuit, a control means externally located on the housing for tuning the matching circuit, and a means of connecting the assembly to a radio system within a vehicle.

In a preferred embodiment, the antenna assembly is provided as an integrated assembly with the antenna radiator connected directly to and integrated with a housing that contains the tunable matching circuit. The housing also contains an input connector for connecting the antenna assembly to a radio system within a vehicle, where the means of connecting may include a water-tight flange-mounted connector on the housing that can enable connection to the radio system by a standard coaxial cable (where the coaxial cable is preferably routed from the housing, through a vehicle electrical cable access hole, to the radio system). When the antenna assembly is manufactured, all the assemblies and connections between each other are water tightened by gaskets and shrink tubes.

As noted above, the housing provides a connection between the antenna radiator and the output of a matching circuit, and also connects the input of the matching circuit to the radio system. In a preferred embodiment, the means for connecting the output of the matching circuit to the antenna radiator includes a flange-mount connector that can be connected to a connector directly integrated with the antenna radiator.

The antenna radiator is preferably flexible, and more preferably is a flexible wire. In such an embodiment, one end of the wire forming an antenna terminal may be soldered to the center pin of a male connector, where the male connector can be subsequently connected with a female flange-mounted connector on the housing that is connected to the output of the matching circuit. Preferably, the antenna wire is further insulated by a plastic sleeve or a dielectric coating and a metallic ferrule is used to provide mechanical support to the connection of the wire and the male connector. The stiffness of the wire near the point of contact with the male connector may be further increased by adding successive layers of heat shrink, with each successive layer of heat shrink extending a shorter length from the male connector.

Embodiments in which the antenna radiator is made from flexible metal wire enable the antenna radiator to be bent easily in various compact spaces, for example in a vehicle bumper or fender with non metallic covers. Advantageously, the antenna radiator may be pre-configured to be bent into a shape that is known to accommodate concealment in a location within a specific vehicle type or make. In another embodiment, a shortened antenna radiator is provided by a coiled wire segment followed by an uncoiled wire segment. In this embodiment, the antenna radiator may be able to be installed within a small space without bending.

In a preferred embodiment, the antenna assembly is concealed within a bumper. In a more preferred embodiment, the assembly is located near a corner of the bumper and at a sufficient height within the bumper to efficiently receive and transmit signals. The antenna radiator may routed through holes cut in the bumper foam, or may be secured to other structures in the bumper, provided that any contact between the antenna radiator and a conductive structure is insulated. The antenna radiator is preferably secured to the foam using fibreglass tape or ties, and is more preferably routed along a channel cut in the upper surface of the foam. Advantageously, the antenna of the present invention requires that only a very small portion of the foam needs to be removed during assembly.

In another embodiment, the antenna may be installed inside a fender, provided that the fender is non-conductive and permits efficient transmission and reception of radio waves. Foams or plastic spacers may be added to support the antenna wire within the fender.

The housing is secured within the vehicle by mounting it to a support within the vehicle. Preferably, the housing is conductive, and the means of mounting the housing to the support is conductive, for example, using self-taping metallic screws. Preferably, the support is a conductive grounding support within the vehicle, whereby the mounting of the housing to the support provides grounding for the antenna assembly. The support may be a vehicle bumper channel or the vehicle body wall inside the fender. The contact points where the housing is mounted to the surface are preferably weatherproofed to preserve the conductive connection. A preferred means of weatherproofing is sealing with an elastomeric sealant.

In a preferred embodiment, the matching circuit is an LC circuit, and is more preferably wide band. The control means for tuning the matching circuit is accessible externally on the housing and preferably comprises a tuning screw of a capacitor trimmer. In an exemplary embodiment, a capacitor trimmer is mounted on the wall of the housing, with the tuning screw accessible through an opening in the housing. The opening is preferably sealed with an o-ring, and a water-tight cap is placed over the tuning screw after the matching circuit is tuned.

The control means enables the matching circuit to be tuned in order to achieve optimum performance for different vehicles and different mounting positions. Furthermore, the tuning screw enables the antenna frequency can be tuned to desired frequency within a certain range. The present invention therefore uniquely provides a simple and effective means to tune the matching circuit before or during assembly.

Comparing to the prior inventions and existing products, the antenna presented in this invention has the advantage of low cost, easy of installation, minimum modification to vehicles, frequency adjustability, broadband and ideal concealment. The antenna is modular design applicable for transmitting and receiving radio frequency signals and adapts well with many vehicle types.

The present invention further provides a concealed antenna system comprising one or more antenna assemblies connected to a radio system, where the radio system comprises a transmitter and/or receiver, or a transceiver. In a preferred embodiment, multiple antenna assemblies are installed within a vehicle, thereby providing a diversity antenna system.

The use of multiple antennas in a diversity application can dramatically improve system performance by providing spatial, pattern, polarization, and transmitter/receiver diversity. For example, a single antenna assembly installed inside the bumper may have its omni-directionality compromised because of the shading of the vehicle body. A diversity scheme employing multiple antenna assemblies can circumvent this problem. In a preferred embodiment, the installation of multiple antenna assemblies within a vehicle is achieved by spacing any two antenna assemblies apart by about at least one half of a wavelength, where the wavelength corresponds to an operating frequency of the system.

In a preferred embodiment, more than one antenna assembly is installed in different corners of the front and rear bumpers. Preferred combinations include: 1) two antennas installed at the two ends of the bumper channel in the same bumper; 2) two antennas are installed at the opposite sides of the front and rear bumpers; 3) four antennas are installed at the four ends of the bumper channels in the front and rear bumpers. It is emphasized that these antennas can be installed in corresponding fenders as long as the fender covers are non-conductive.

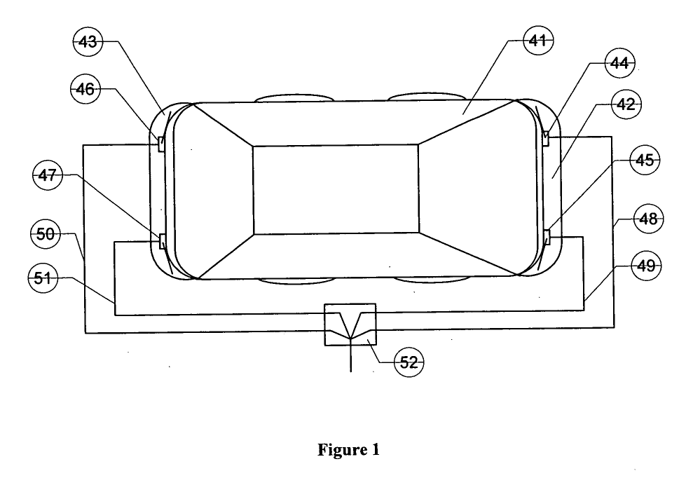

An exemplary embodiment involving multiple antenna assemblies is shown in FIG. 1, in which antennas 44,45,46,47 presented in this invention are placed at different corners inside the bumpers 42, 43 and are combined into the transceiver (not shown in the figure) by a power divider 52. Different number of antennas can be used to reduce the shading effect of depending one the size of vehicle body 1 and antenna working frequencies. Furthermore, different antenna orientations can mitigate polarization-dependent signal degradation. As mentioned above, a preferred embodiment includes two antennas located on the diagonal, which means if two antennas are installed, antennas 44 and 47, or antennas 45 and 46 should be installed. It is also possible to further optimize the omni-directivity by adjusting the lengths of feed cables 48, 49, 50 and 51.

In another embodiment of the combination spatial diversity system described above, the signals from the antenna assemblies are weighted and combined coherently, whereby the coherent and weighted combination of signals produces an improved overall signal quality.

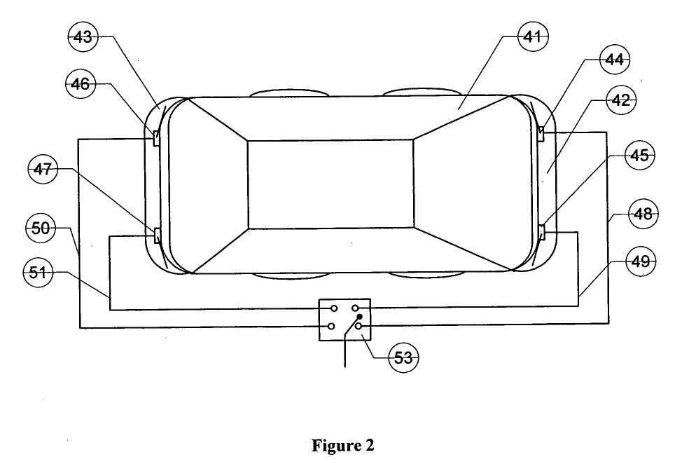

In the second configuration for applying multiple antenna assemblies as shown in FIG. 2, the antenna assemblies are connected to the transceiver through a RF switch 53. Unlike the configuration given in FIG. 1, only one antenna assembly which has the best signal is connected to the transceiver. If the signal from the antenna assembly degrades below a pre-selected threshold, the switch is activated and a different antenna assembly with improved signal quality is selected. A mechanical switch can be used to choose the proper antenna assembly manually. In one embodiment, the switch is a device that can switch automatically via a control signal from the radio system. A preferred embodiment with two antenna assemblies involves the placement of the antenna assemblies on the diagonal, as 44 and 47, or antenna assemblies 45 and 46.

In another embodiment of the switching diversity system described above, the signal quality of the antenna assemblies that are not connected to the transceiver is monitored. If the signal from the antenna assembly degrades below a pre-selected threshold, the switch is activated and the antenna assembly with the optimal signal quality (based on the monitoring measurements) is selected, thereby enabling a rapid improvement of signal quality without significant loss of information.

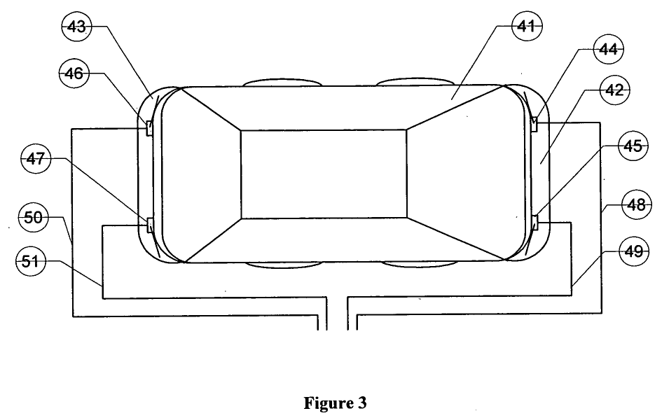

The antennas 44, 45, 46, 47 presented in this invention may also be used in a more advanced system whereby the antenna assemblies are connected to a multiple input multiple output system. In FIG. 3, the antennas are connected to a multiple-input multiple-output (MIMO) transceiver (not shown in the figure) independently. In this embodiment, some antenna assemblies operate as transmitters and others operate as receivers. The transceiver will process the signals received from different receiving antennas to improve the signal level. The transceiver may also use more than one antenna assembly to transmit signals. In general, this type of transceiver can transmit and receive multiple data streams via multiple antenna assemblies.

The invention is further illustrated by the following non-limiting example.

### EXAMPLE

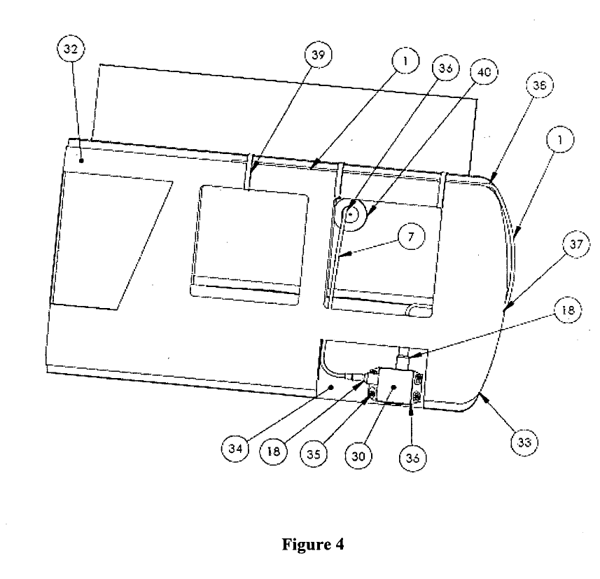

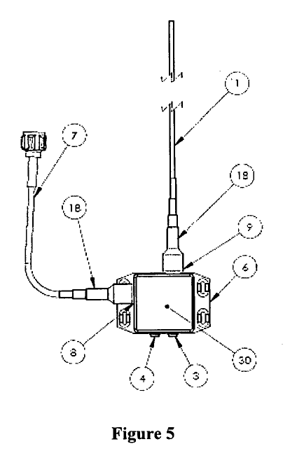

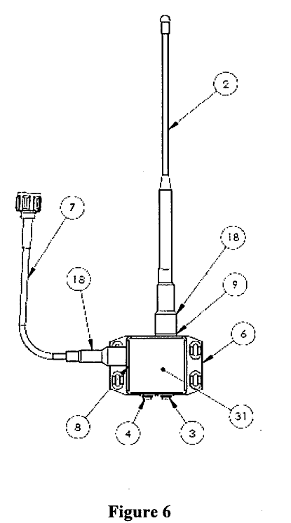

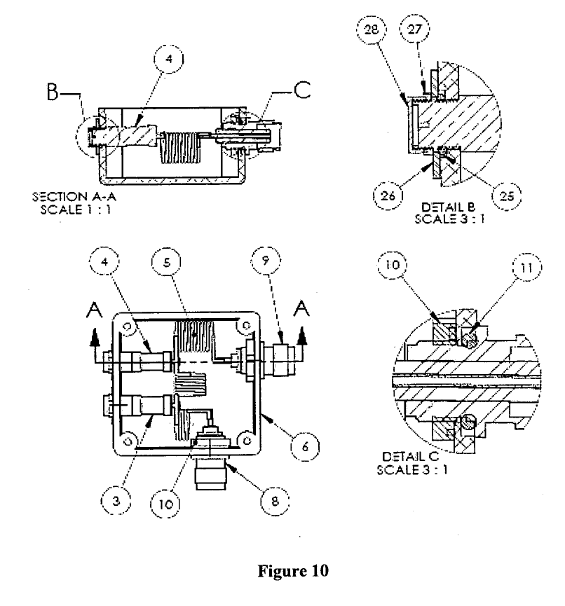

In the following example, a preferred embodiment is provided in which an integrated antenna assembly is disclosed for concealment within a bumper or non-metallic fender. Referring to FIGS. 4 through 10, the vehicle mounted concealed antenna system disclosed herein includes an antenna radiator 1 (FIG. 5) or 2 (FIG. 6), and a matching circuit network consisting of two capacitor trimmers 3, 4, inductor coils 5 (shown in FIG. 10), environmentally sealed metal mounting base 6 (referred to in the preceding discussion as a housing), feed cable 7 and feed connector 8, antenna output connector 9. The female connectors 8 and 9 are arranged and mounted by hex nuts 10 and o-ring seals 11 into the walls of the mounting base 6.

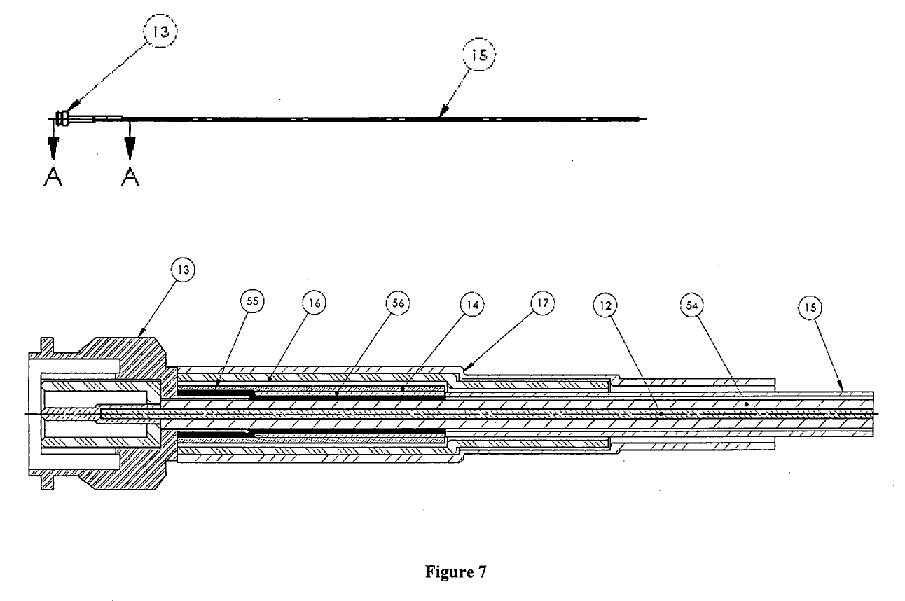

A detailed view of a preferred embodiment of the antenna radiator is shown in FIG. 7. The antenna radiator 1 consists of a copper wire 12, dielectric sleeve 54, male connector 13, two copper ferrules 14, braided wire 55, outer jacked 56, and shrink tubing 15.

The end of the inner conductor 12 is soldered into the male connector pin 13 but the opposite end of the wire is left open. The inner conductor's 12 entire length is covered by dielectric 54 and protected over the full length with the first layer of shrink tubing 15.

A portion of the braided wire 55 is soldered to the extension of the connector body 13, the outer jacked 56 is placed over the other part of the braided wire to hold the braided wire against the dielectric sleeve 54. The metal ferrules 56 crimp and sandwich the braided wire 55 against the connector extension 13 to firm-up construction.

The first layer of shrink tubing 15 is heat shrunk in place over the entire length of the antenna, a second layer 16 of a shorter length shrink tubing is placed over the metal ferrules 14 to add flex strength to the antenna near the connector, a third layer of shrink tubing 17 of a different length is heat shrank over the top of the second and first layer of shrink tubing to moisture seal the connector and to add stiffness to the second and first layer shrink tubing. The layered shrink tubing design makes the radiating antenna 1 construction unique with respect to flexibility and stiffness.

As shown in FIG. 5, the radiating antenna 1 is attached by male and female connectors on the antenna side and screwed together at the point of installation. The antenna connection to connector 9 is covered by a forth layer of shrink tubing 18. The forth layer covers the connector male coupling nut 13 and the outside female connector 9. This unique construction contributes to the antennas ridged but flexible connection.

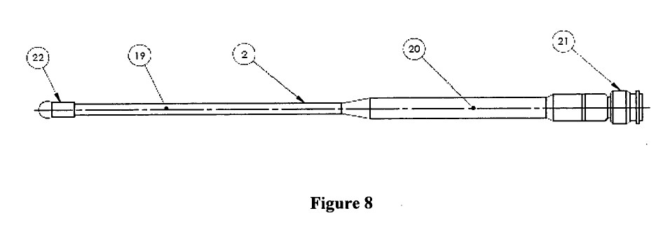

FIG. 8 shows another embodiment, wherein the antenna radiator 2 consists of a straight wire 19 with coiled wire bottom 20 to reduce the length of the antenna, and the inner pin of the male connector 21 is soldered to the bottom end of the coiled wire. The wire is covered by a dipping into a batch of insulating material. The antenna top is covered by a plastic cap 22.

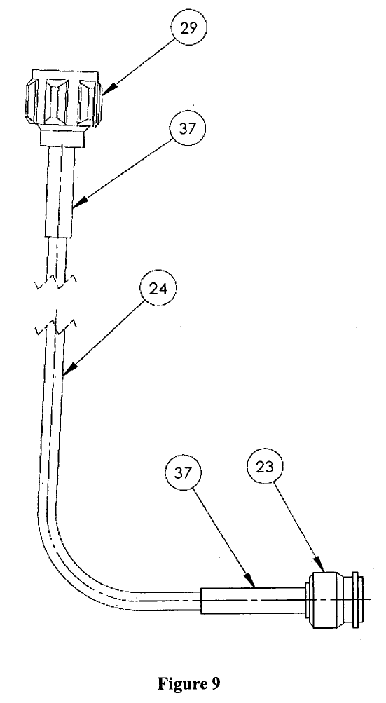

The feed cable 7, shown in FIG. 9, consists of a coaxial cable 24, male connector 23 on the matching circuit side and, a male or female connector 29 on the transceiver side. Both connectors and the coax cable are sealed by shrink tubing 37.

As shown in FIG. 10, two female connectors connect other parts of the antenna system outside of the mounting base with the enclosed matching circuit. Female connector 9 is attached to the antenna radiator 1 or 2, and female connector 8 is connected to the feed cable 7.

The matching network, also shown in FIG. 10, consists of two capacitor trimmers 3 and 4, and a three-in one coil inductor coil 5. The capacitor trimmers are mounted thru the enclosure wall in such a way that the capacitors tuning screws are accessible from the outside of the enclosure for tuning purposes, the capacitor trimmers are o-ring sealed 25 and tightened by washer 26 and nut 27 and caped 28 to prevent water and moisture from entering the enclosure.

The inductor coil 5 consists of three separate coils connecting the antenna input connector 9 via the capacitor 4 and capacitor 3 to the feed connector 8. The concealed antenna system 30 is an environmentally sealed unit consisting of antenna 1, sealed mounting base 6 (enclosure, lid with gasket screws), matching network circuit and feed cable 7.

As shown in FIGS. 5 and 6, the concealed antenna system 30 or 31 is an environmentally sealed unit consisting of antenna I or 2, sealed enclosure 6 (enclosure, lid with gasket screws), matching network circuit and feed cable 7. The concealed antenna system 30 or 31 is installed under the rear or front of the vehicle outer bumper near the left or right hand corner.

Further to the aforementioned example, a method of installation of the antenna assemble is now disclosed with reference to FIG. 4. To obtain access to the inner region of a vehicle bumper, the outer ABS-bumper (not shown) must be removed and the inner styrofoam bumper 32 must be modified by a cut-out in order to get access to the metal support bumper 33. The metal support bumper (rolled steel channel) is used during installation to provide sufficient grounding to the antenna system, therefore the mounting area 34 which is placed under the metal mounting base 6 must be metallically clean to ensure a solid grounding for the antenna network enclosure.

The antenna mounting base 6 is bolted to the steel bumper channel 33 by four self tapping screws 35. After installation the contact area between the metal bumper channel 33 and the sealed mounting base 6 must be sealed with a flexible, weather resistant coating 36 to prevent moister ingression and corrosion. The antenna radiator 1 is routed thru predrilled holes into the styrofoam bumper 37 and then laid across the groove 38 at the top of the styrofoam bumper. Fiber glass tape or tie wraps 39 are used to secure the antenna against the styrofoam bumper.

The feed cable 7 is attached to the feed connector 8 and routed thru the styrofoam bumper via the existing grommet 40 into the inside of the trunk of the vehicle. The grommet 40 must be resealed with weather resistant coating 36 after wire routing.

The aforementioned method may be employed to install an antenna assembly in an existing vehicle as an aftermarket assembly, or alternatively during the assembly of a new car.

The examples and embodiments described herein are for illustrative purposes only. Modifications or changes in light thereof will be suggested to persons skilled in the art and are to be included within the spirit and purview of this application.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

As used herein, the terms “about”, and “approximately” when used in conjunction with ranges of concentrations, temperatures or other physical or chemical properties or characteristics is meant to cover slight variations that may exist in the upper and lower limits of the ranges of properties/characteristics.

Also, as used herein, the terms “comprises”, “comprising” , “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. An antenna assembly adapted for use with a vehicle, comprising:
(a) an antenna radiator;
(b) a matching circuit contained within a housing; and
(c) control means for tuning said matching circuit;
wherein said housing further comprises a first external connection means for directly connecting an output of said matching circuit to said antenna radiator and a second external connection means for connecting an input of said matching circuit to a radio system.

2. The antenna assembly according to claim 1 wherein said antenna radiator is flexible.

3. The antenna assembly according to claim 2 wherein said antenna radiator is coated with a dielectric material.

4. The antenna assembly according to claim 3 wherein said antenna radiator is a wire.

5. The antenna assembly according to claim 4 wherein said wire is a copper wire.

6. The assembly according to claim 1 wherein said antenna radiator is bent to a predetermined shape for concealing said antenna radiator within a vehicle.

7. The antenna assembly according to claim 4 wherein said wire is coiled over a first length of said antenna radiator and uncoiled over a second length of said antenna radiator.

8. The antenna assembly according to claim 1 wherein said first external connection means is a flange-mount connector.

9. The antenna assembly according to claim 8 wherein said antenna radiator is connected to the center pin of a male coaxial connector and said flange-mount connector is a female coaxial connector that interfaces with said male coaxial connector.

10. The antenna assembly according to claim 9 wherein a connection of said antenna radiator to said male coaxial connector includes a strain-relief means and a weatherproofing means.

11. The antenna assembly according to claim 1 wherein said second external connection means is a flange-mount connector.

12. The antenna assembly according to claim 11 wherein said flange-mount connector interfaces with a standard coaxial cable.

13. The antenna assembly according to claim 12 wherein said antenna assembly further includes a length of coaxial cable connected to said flange-mount connector.

14. The antenna assembly according to claim 13 wherein said antenna assembly includes a weatherproofing means for protecting said connection between said coaxial cable and said flange-mount connector.

15. The antenna assembly according to claim 1 wherein said matching circuit comprises an LC network.

16. The antenna assembly according to claim 15 wherein said LC network includes at least one capacitor trimmer and wherein said control means are tuning screws of said one or more capacitor trimmers and wherein said one or more capacitor trimmers are mounted through a wall of said housing so that said tuning screws are accessed externally.

17. The antenna assembly according to claim 16 wherein each interface between said capacitor trimmers and said wall is sealed with an o-ring.

18. The antenna assembly according to claim 16 wherein said tuning screws are sealed with water-tight caps after said matching circuit is tuned.

19. The antenna assembly according to claim 16 wherein said LC network is a wideband circuit and comprises two capacitor trimmers and three inductive coils, wherein a first inductive coil is connected between a first external connection means and a first terminal of a first capacitor trimmer, a second inductive coil is connected between a second terminal of said first capacitor trimmer and a first terminal of a second capacitor trimmer, and a third inductive coil is connected between a second terminal of said second capacitor trimmer and said second external connection means.

20. The antenna assembly according to claim 1 wherein said housing is weatherproofed and includes a means for attaching said housing to a support within said vehicle.

21. The antenna assembly according to claim 20 wherein said housing is conductive, said support is a grounding conductive support, said attachment means is conductive, and the attachment of said housing to said support provides grounding for said antenna assembly.

22. The use of an antenna assembly according to claim 1 as an after-market assembly for installation into a vehicle, and wherein said antenna assembly is concealed within a bumper or non-conductive fender of said vehicle.

23. The use of an antenna assembly according to claim 1 in the assembly of a new vehicle, and wherein said antenna assembly is concealed within a bumper or non-conductive fender of said vehicle.

24. A antenna system concealed within a vehicle comprising one or more antenna assemblies, wherein said one or more antenna assemblies are connected to a radio transmitter, receiver or transceiver, and said one or more antenna assemblies each individually comprise:
(a) an antenna radiator;
(b) a matching circuit contained within a housing; and
(c) control means for tuning said matching circuit;
wherein said housing further comprises a first external connection means for directly connecting an output of said matching circuit to said antenna radiator and a second external connection means for connecting an input of said matching circuit to a radio system.

25. The antenna system according to claim 24 wherein each antenna radiator is flexible.

26. The antenna system according to claim 25 wherein each antenna radiator is coated with a dielectric material.

27. The antenna system according to claim 26 wherein said each antenna radiator is a wire.

28. The antenna system according to claim 27 wherein said wire is a copper wire.

29. The antenna system according to claim 24 wherein each antenna radiator is bent to a predetermined shape for concealing said each antenna radiator within said vehicle.

30. The antenna system according to claim 27 wherein said wire is coiled over a first length of said each antenna radiator and uncoiled over a second length of said each antenna radiator.

31. The antenna system according to claim 24 wherein each first external connection means is a flange-mount connector.

32. The antenna system according to claim 31 wherein each antenna radiator is connected to the center pin of a male coaxial connector and said flange-mount connector is a female coaxial connector that interfaces with said male coaxial connector.

33. The antenna system according to claim 32 wherein a connection of said each antenna radiator to said male coaxial connector includes a strain-relief means and a weatherproofing means.

34. The antenna system according to claim 24 wherein each second external connection means is a flange-mount connector.

35. The antenna system according to claim 34 wherein said flange-mount connector interfaces with a standard coaxial cable.

36. The antenna system according to claim 35 wherein each of said one or more antenna assemblies further includes a length of coaxial cable connected on one end to said flange-mount connector and on another end to a weatherproofed feed through connector mounted in the body said vehicle, whereby said feed through connector is connected to a radio system secured within said vehicle.

37. The antenna system according to claim 36 wherein each of said antenna assembly includes a weatherproofing means for protecting said connection between said coaxial cable and said flange-mount connector.

38. The antenna system according to claim 24 wherein each matching circuit comprises an LC network.

39. The antenna system according to claim 38 wherein said LC network includes at least one capacitor trimmer and wherein said control means are tuning screws of said one or more capacitor trimmers and wherein said one or more capacitor trimmers are mounted through a wall of said housing so that said tuning screws are accessed externally.

40. The antenna system according to claim 39 wherein each interface between said capacitor trimmers and said wall is sealed with an o-ring.

41. The antenna assembly according to claim 39 wherein said tuning screws are sealed with water-tight caps after said matching circuit is tuned.

42. The antenna system according to claim 39 wherein said LC network is a wideband circuit and comprises two capacitor trimmers and three inductive coils, wherein a first inductive coil is connected between a first external connection means and a first terminal of a first capacitor trimmer, a second inductive coil is connected between a second terminal of said first capacitor trimmer and a first terminal of a second capacitor trimmer, and a third inductive coil is connected between a second terminal of said second capacitor trimmer and said second external connection means.

43. The antenna system according to claim 24 wherein each housing weatherproofed and is attached to a support within said vehicle by an attachment means.

44. The antenna system according to claim 42 wherein said each housing is conductive, said support is a conductive grounding support, said attachment means is conductive, and the attachment of said each housing to said support provides grounding for said antenna assembly.

45. The antenna system according to claim 44 wherein the attachment between said each housing and said support is weatherproofed.

46. The antenna system according to claim 45 wherein said weatherproofing is provided by an elastomeric sealant disposed around the contact between said each housing and said support.

47. The antenna system according to claim 24 wherein each of said one or more antenna assemblies is individually mounted behind a non-conductive fender.

48. The antenna system according to claim 47 wherein each antenna radiator is supported within said fender by insulating foam or plastic spacers.

49. The antenna system according to claim 25 wherein said each antenna radiator is routed through openings created within foam contained in said bumper, and wherein said each antenna radiator is further secured to said foam by a securing means.

50. The antenna system according to claim 49 wherein said each antenna radiator is secured at a maximal height within said foam in said bumper to obtain optimal performance.

51. The antenna system according to claim 49 wherein said antenna radiator is further secured within a groove at the top of said foam, said groove extending in a longitudinal direction substantially parallel to the long axis of said bumper.

52. The antenna system according to claim 49 wherein said securing means is selected from the list comprising fibreglass tape and tie wraps.

53. The antenna system according to claim 24 comprising a diversity antenna system wherein said one or more antenna assemblies comprise two or more antenna assemblies that are mounted within one or more bumpers of said vehicle, and wherein each of said one or more antenna assemblies are separated by a minimum spacing of about one half of a wavelength, where said wavelength corresponds to an operating frequency of said radio system.

54. The antenna system according to claim 53 wherein said two or more antenna assemblies comprise two antenna assemblies for use in a diversity radio system.

55. The antenna system according to claim 54 wherein said two antenna assemblies are housed in opposite diagonal corners in the front and rear bumpers of said vehicle.

56. The antenna system according to claim 54 wherein said two antenna assemblies are housed in opposite corners within a single bumper of said vehicle.

57. The antenna system according to claim 53 wherein said one or more antenna assemblies comprise four antenna assemblies, wherein two antenna assemblies are housed in opposite corners within a front bumper of said vehicle, and two antenna assemblies are housed in opposite corners within a read bumper of said vehicle.

58. The antenna system according to claim 53 wherein said two or more antenna assemblies are further arranged so as to provide both spatial and polarization diversity.

59. The antenna system according to claim 53, wherein said two or more antenna assemblies are each connected to a outputs of a power divider by coaxial cables, wherein an input of said power divider is connect to a diversity radio system, and wherein the lengths of said coaxial cables are chosen to provide suitable system performance.

60. The antenna system according to claim 59 wherein said lengths of said coaxial cables are chosen for a specific vehicle design using simulation software.

61. The antenna system according to claim 53, wherein said two or more antenna assemblies are connected to a signal combining means whereby the signals of all of said two or more antenna assemblies are weighted and coherently added to produce an optimal signal for output to a transceiver.

62. The antenna system according to claim 53, wherein said two or more antenna assemblies are each connected to outputs of a switch, and wherein an input of said switch is connected to a diversity radio system.

63. The antenna system according to claim 62, wherein said diversity radio system operates in a switching mode wherein a single antenna assembly is connected to said diversity radio system at a given time, and whereby the degradation of a signal from said single antenna assembly below a pre-selected threshold results in the switching of said switch to a different antenna assembly for improved reception.

64. The antenna system according to claim 63, wherein said diversity radio system operates in a selection mode wherein a single antenna assembly is connected to a transceiver of said diversity radio system at a given time, but wherein the quality of signals from all other antenna assemblies is monitored by said diversity radio system, and whereby the degradation of a signal from said single antenna assembly below a pre-selected threshold results in the connection of the antenna assembly with optimal signal quality.

65. The antenna system according to claim 53, wherein said two or more antenna assemblies are connected to inputs of a multiple-input multiple-output (MIMO) transceiver.

66. A method of installing an antenna assembly according to claim 1 in a vehicle bumper, comprising the steps of:
(a) removing an outer bumper cover to expose foam within said bumper;
(b) creating holes within said foam for the routing of said antenna radiator;
(c) routing said antenna radiator through said holes and securing said antenna radiator using a securing means;
(d) mounting said housing to a support within said bumper;
(e) connecting said second external connection means to a radio system within the body of said vehicle.

67. The method according to claim 66 wherein said step of connecting said second external connection means to a radio system within the body of said vehicle includes connecting said second external connection means to a radio system using a coaxial cable, and further includes passing said cable through a grommet in a wall of said body of said vehicle and subsequently sealing said grommet.

68. The method according to claim 66 wherein said housing is conductive, said support is a grounding conductive support, said attachment means is conductive, and the attachment of said housing to said support provides grounding for said antenna assembly.

69. The method according to claim 68 wherein said support is mechanically clean at a contact location between said conductive housing and said support.

70. The method according to claim 69 wherein the attachment between said housing and said support is weatherproofed.

71. The method according to claim 70 wherein said weatherproofing is provided by an elastomeric sealant disposed around the contact between said housing and said support.
